(19) United States
(12) Patent Application Publication
(10) Pub. No.: US 2026/0326118 A1
(43) Pub. Date: Oct. 22, 2026

(54) Method and Device for Monitoring a Centrifuge

(71) Applicant: Siemens Aktiengesellschaft, Muenchen (DE)

(72) Inventor: Ansgar KURSAWE, Niedernhausen (DE)

(21) Appl. No.: 19/113,955

(22) PCT Filed: Sep. 21, 2023
(86) PCT No.: PCT/EP2023/076107

§ 371 Date: Mar. 21, 2025

(30) Foreign Application Priority Data
Sep. 22, 2022 (EP) 22197197

(51) Int. Cl. B04B 11/04; B04B 3/00; B04B 13/00

(52) U.S. Cl. CPC B04B 11/04; B04B 3/00; B04B 2013/006

(57) ABSTRACT

A method and device for monitoring a centrifuge for solid-liquid separation of a suspension includes a centrifuge drum that is connected to at least one frequency-controlled drive for generating a rotation of the centrifuge drum, wherein during operation of the centrifuge a plurality of variables and parameters of the drive are determined time-dependently over the course of the separating process, and operating modes of a cycle of the centrifuge operation are derived from the correlation of the variables and parameters, and information relating to the separating process is automatically acquired depending on the derived operating mode.

### CROSS-REFERENCE TO RELATED APPLICATIONS

This is a U.S. national stage of application No. PCT/EP2023/076107 filed 21 Sep. 2023. Priority is claimed on European Application No. 22197197.1 filed 22 Sep. 2022, the content of which is incorporated herein by reference in its entirety.

### BACKGROUND OF THE INVENTION

### 1. Field of the Invention

The invention relates to a method, computer program, computer program product and device for monitoring a centrifuge for solid-liquid separation of a suspension.

### 2. Description of the Related Art

Centrifuges are technical devices used to separate substances. The mode of operation of centrifuges is based on centrifugal force that is created by a uniform circular movement of the material to be centrifuged. Particles or media with higher density migrate outward due to higher inertia. In doing so, they displace components with a lower density, which then move to the center.

Centrifuges, such as peeler centrifuges, are often used in the pharmaceutical industry or the food industry (for example, in sugar production) for solid-liquid separation of a suspension. As a rule, such centrifuges are operated in accordance with a fixed time program: a suspension is fed from a vessel into the centrifuge via a time-controlled valve, where the time is limited based on empirical values due to the risk of overfilling. The centrifuge has a centrifuge drum that is filled with the suspension as filling material at the beginning of each work step, where the centrifuge initially rotates at a first speed (filling speed DZ1, see FIG. 2). The centrifuge drum is then accelerated to a second speed (spin speed DZ2, FIG. 2), which is significantly higher than the first speed. This speed is maintained until the desired drying progress is achieved in the filling material. The so-called filter cake remains on the filter cloth. The centrifuge drum is then slowed down to a peeling speed (DZ3, FIG. 2) and the filling material is removed from the centrifuge drum with a clearing facility or peeling device. After a certain number of runs of this type, as a rule, the filtration resistance due to a clogged filter cloth or a non-removable base layer is so high that thorough cleaning is necessary.

The throughput of a centrifuge depends on the filtration resistance, which in turn depends on the particle size distribution. Small fluctuations in the particle diameter lead to significantly different separation times. A time controller must therefore be parameterized very precisely. The parameters required for optimal centrifuge operation, such as the mass supplied for material separation and the speed used, are usually set manually for each batch by centrifuge operating personnel based on empirical values. Conventional condition monitoring, in which the technical condition of the unit is recorded regularly or permanently with the aid of sensors and the result is analyzed for further use, is difficult with centrifuges because attaching a sensor in the separation chamber within the centrifuge drum is likewise difficult. In addition, conventional sensor technology is always exposed to high levels of contamination from the suspension.

Some peeler centrifuges have a type of “paddle” that slides on the rotating liquid or the filter cake separated therefrom via a displacement sensor, thus allowing the filling level of the centrifuge to be estimated. Unfortunately, these mechanical sensors can transmit incorrect values due to caking of the suspension and can, for example, jam. Exact monitoring of the separating process or the condition of the centrifuge is therefore not possible. Non-contact optical sensors using lasers or ultrasound are likewise susceptible to failure due to contamination with a high solids content and are difficult to use. There is therefore a need to monitor the condition of a centrifuge contactlessly and yet precisely to ensure a smooth error-free operation without installing complicated sensor technology on the centrifuge itself or the need to set unnecessarily short filling times or excessively long spin times, thereby reducing the throughput of the centrifuge.

### SUMMARY OF THE INVENTION

In view of the foregoing, it is therefore an object of the invention to provide an improved method for monitoring centrifuges and the separating process to be performed in which no sensor technology has to be attached in or on the centrifuge.

The core idea of the invention is to evaluate existing variables and/or parameters of the centrifuge drive for controlling and regulating the centrifuge in such a way that they can be used to monitor the separating process and/or the centrifuge condition. These can be physical variables such as current, voltage, speed (angular velocity) or torque, or variables derived therefrom with the corresponding parameters, such as the rotational moment of inertia, the angular momentum of the centrifuge drum or the mass inflow. Accordingly, the inventive method is based both on simple data accessible by measurement technology, such as current or voltage, and data ascertained by calculation.

These and other objects and advantages are achieved in accordance with the invention by a method for monitoring a centrifuge for solid-liquid separation of a suspension, comprising a centrifuge drum, which is connected to at least one frequency-controlled drive for generating a rotation of the centrifuge drum, where, during operation of the centrifuge, a plurality of variables and/or parameters of the drive are ascertained time-dependently over the course of the separating process, and operating modes of the centrifuge are derived from the correlation of the variables and/or parameters with one another, and information relating to the separating process and/or a centrifuge condition is automatically ascertained depending on the derived operating mode.

The advantage of the method in accordance with the invention is that both the separating process and the centrifuge itself can be monitored based on existing variables and/or parameters of the drive without the need for additional sensor technology. Accordingly, the invention does not require any special additional measuring instruments, but rather makes do with the instrumentation usually found in frequency converters.

The inventive method can advantageously be implemented in software or firmware at the control level and is therefore flexibly adaptable. In principle, any type of centrifuge can be equipped with “smart” monitoring software based on the method in accordance with the invention. All that is required is a suitable software module for evaluation.

In a first embodiment, it is advantageously possible to ascertain the fill level of the centrifuge drum or to determine a targeted fill amount. In this embodiment, the centrifuge is monitored such that, the drive energy required to maintain a speed of the drum rotation is recorded time-dependently and an increase in the rotational moment of inertia of the drum due to the filling is derived therefrom. It is easy to determine the (rotating) mass of the filling of the centrifuge drum therefrom.

This embodiment is particularly suitable for the operating mode in which the centrifuge drum rotates at the fill speed. How much power the centrifuge consumes when empty at a constant speed is initially ascertained, and the rotational moment of inertia of the empty drum can be derived therefrom. The centrifuge is then filled (the valve for the mass inflow of the suspension is opened). When the drum is filled, the incoming mass flow has to be accelerated to its angular velocity and the additional energy required to accelerate an additional (inflowing) mass has to be recorded via the power consumed by the frequency converter (at a constant angular velocity). This additional energy is used to ascertain the mass of the filling of the drum. The feed valve is then closed. Therefore, the power consumption of the frequency converter increases significantly during the fill process. The integral of the current consumption above the idle current consumption at this speed is accordingly a measure of the mass filled. The moment of inertia of the centrifuge drum can therefore be easily inferred from the electrical energy required by the drive if the speed is known. When determining the rotational moment of inertia, the centrifuge drum can always be considered to be a hollow cylinder because, as a rule, the radius of the centrifuge is very large compared to the almost negligible layer thickness of the filling material in the drum.

The advantage of the present embodiment is that that the fill level of the centrifuge can be determined very easily and yet quite precisely. The energy required to accelerate the rotating mass can be precisely measured based on the trends in current or electrical power and is characteristic of a filling process. The virtual increase in mass during the filling process is characteristic of the process.

In an additional advantageous embodiment, the idle moment (or rotational moment of inertia of the drum when empty) is ascertained. Here, the additional energy required to increase the rotational moment of inertia is ascertained for the centrifuge drum when empty during transition from a first speed (preferably the peeling speed) to a second speed (preferably the fill speed). This is used to infer the (rotating) mass of the empty drum. This embodiment is particularly important if the fill level of the filled centrifuge drum is not determined solely by an increase in energy. In this way, it is very easy to determine the unladen weight of often very heavy and large centrifuge drums, such as those found in the sugar industry, for example. The idle moment or the drum's unladen weight is essential in many cases for further evaluations.

The fill level of the centrifuge can also be determined easily and precisely in a further advantageous embodiment. This embodiment is particularly suitable for high speeds, i.e., for operating mode speeds in which the centrifuge drum rotates at the spin speed. Herein, the speed of the drum rotation is varied cyclically over time and the time change in angular velocity is measured. The energy for the acceleration and deceleration of the drum is derived from this and the rotational moment of inertia of the drum is calculated. Knowledge of the zero mass (which results from the rotational moment of inertia of the centrifuge when empty) enables the filling level of the centrifuge drum to be determined using the rotational moment of inertia of the rotating mass.

The advantage of the presently contemplated embodiment is that the small variation in speed has no impact on the separating process, while the change in energy caused by the acceleration and deceleration of the drum can be easily measured by the change in angular velocity over time. As in the first embodiment, the change in energy is used to infer the moment of inertia of the drum and then the filling level.

In a further advantageous embodiment, the residual moisture of a filter cake is determined at the high speed by comparing the rotating masses of at least two cycles of speed variations. In this embodiment, the speed is first varied at the spin speed of the centrifuge drum, the rotating mass is determined and then the process is repeated at least once. If the mass determined in this way no longer changes, then there is no longer any residual moisture in the filter cake in question to spin off. The mass determined is constant upon complete dehumidification. In this way, the residual moisture of the filter cake can be determined very efficiently without intervening in the separating process, such as by taking a sample. Furthermore, there are also no additional operating costs for the centrifuge. On the one hand, the determination of the residual moisture in accordance with the present embodiment is advantageously integrated into the current operating mode of the centrifuge and, on the other hand, the spinning process can be terminated when the filter cake has reached a certain degree of dryness. The operating costs of the centrifuge can ultimately even be reduced by using the present embodiment if the spinning process is terminated earlier than originally specified based on empirical values.

In a particularly advantageous embodiment of the invention, the energy required to maintain or change the rotation of the centrifuge drum is ascertained via integrators in the frequency-dependent converter. No additional sensor technology is necessary. The existing measuring setup is thus optimally utilized.

All disclosed embodiments of the method in accordance with the invention lead to improved monitoring of centrifuges, because the evaluation of existing variables provides greater accuracy and can be completely automated. The method in accordance with the disclosed embodiments of the invention can be provided as a stand-alone application in a process plant or in a local or remote computer system (“cloud”), for example, by a service provider as “software as a service”.

The invention or a disclosed embodiments can also be realized by a computer program, in particular a software application, with program code instructions for implementing the method, where the instructions can be executed by a computer when the computer program is executed on a computer.

The invention and/or each disclosed embodiments can also be realized by a computer program product, which has a non-transitory computer-readable storage medium on which a computer program is stored that executes the invention and/or the development.

The computer program product can advantageously be transferred to a working memory of a computing unit from where it can be executed with the aid of at least one CPU. The computer program product can advantageously be stored on a data memory such as a USB stick, a hard disk or a CD-ROM/DVD-ROM from where it can be retrieved or installed on the computing unit.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The following describes and explains the invention in more detail with reference to the exemplary embodiments shown in the figures, in which:

FIG. 1 is a block diagram of a horizontal centrifuge and a device for monitoring the centrifuge in accordance with the invention;

FIG. 2 is a graphical plot of different time profiles of variables for monitoring a centrifuge over a cycle of centrifuge operation in accordance disclosed embodiments of the invention;

FIG. 3 is a graphical plot of a time profile of the inflow rate and the required motor current in the operating mode of ascertaining the filling level of a centrifuge drum in accordance with a first embodiment of the invention;

FIG. 4 is a graphical plot of a time profile of a speed of a centrifuge in accordance with a further embodiment of the invention; and

FIG. 5 is a flowchart of the method in accordance with the invention.

### DETAILED DESCRIPTION OF THE EXEMPLARY EMBODIMENTS

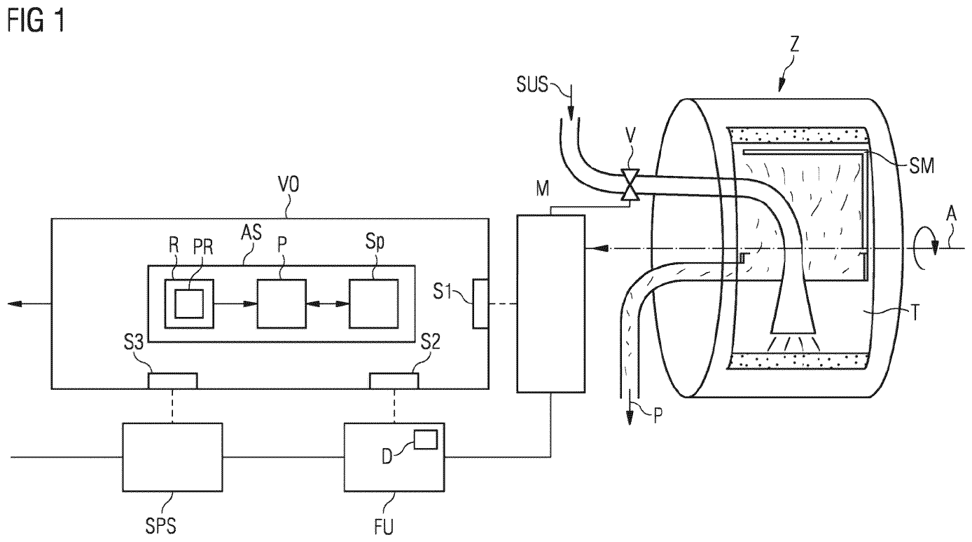

FIG. 1 shows by way of example a simplified block diagram of a horizontal centrifuge Z for solid-liquid separation of a suspension SUS. The centrifuge Z has a centrifuge drum T into which the suspension SUS is fed via a pipe that can be closed by a valve V. The centrifuge drum T has an axis of rotation A that coincides with the axis of symmetry of the centrifuge drum and is arranged horizontally in FIG. 1. The centrifuge has at least one bearing per point at any two points on the axis of rotation for bearing.

In the illustrated embodiment, the suspension SUS is introduced into the interior of the centrifuge drum T via a so-called filling bar. In spinning mode, the filling material rests more or less evenly against the cylindrical wall of the drum due to centrifugal forces. The horizontal centrifuge accelerates in order to press the liquid through the so-called filter cake. Spinning continues until the desired residual moisture of the filter cake is reached. At reduced speed, a peeling knife SM swings into the filter cake and, in this embodiment, peels the product P vertically downward via a discharge device.

To operate the centrifuge Z, it is connected to a frequency-controlled drive for generating a rotation of the centrifuge drum T. The frequency-controlled drive comprises at least one frequency converter FU, which generates a suitable alternating voltage for a motor from a supplying alternating voltage. The frequency converter FU is connected, on the one hand, to a three-phase motor M and, on the other hand, to a programmable logic controller PLC for controlling the motor operation. The frequency converter has a speed control D so that any speeds of the axis of rotation (physically: angular velocities ω) of the centrifuge drum can be set.

A device VO in accordance with the invention for monitoring the centrifuge shown by way of example in FIG. 1 comprises at least one interface (S1, S2, S3) for receiving and exchanging signals from at least one of the units of the motor M, the frequency converter FU and/or the programmable logic controller PLC. Alternatively, the device VO can also have a single interface, which is configured to receive any signals and/or data.

Furthermore, the device VO comprises an evaluation unit AS, which is configured to perform the method in accordance with the invention and, based on the signals supplied, to record a plurality of variables and/or parameters of the drive time-dependently over the course of the separating process during operation of the centrifuge Z, and to derive operating modes of the centrifuge from the correlation of the variables and/or parameters and to ascertain information relating to the separating process and/or a centrifuge condition depending on the derived operating mode. The evaluation unit thus functions as a monitoring facility and can display the previously ascertained information to a user by connection to a display device. Herein, in accordance with the present invention, this can be the filling level of the centrifuge or information about the wear of parts of the centrifuge, such as the bearing of the centrifuge drum or an existing imbalance (=a distribution of mass that is not rotationally symmetrical in rotating bodies).

For this purpose, the evaluation unit AS further comprises at least one processor unit P, at least one memory or an archive Sp for storing the received signals and at least one memory R in which a program PR with instructions is stored which, when it is executed by the processor P, executes one of the above-described methods. The invention implemented as a computer program PR can, for example, be held in the working memory R or loaded into it and can be executed from there with the aid of the at least one processor P.

The device can further have, or be connected to, a display unit, which is configured such that the centrifuge of a process engineering system can be monitored on a user interface GUI. A user can interact with the evaluation unit AS of the device VO as desired via the graphical user interface.

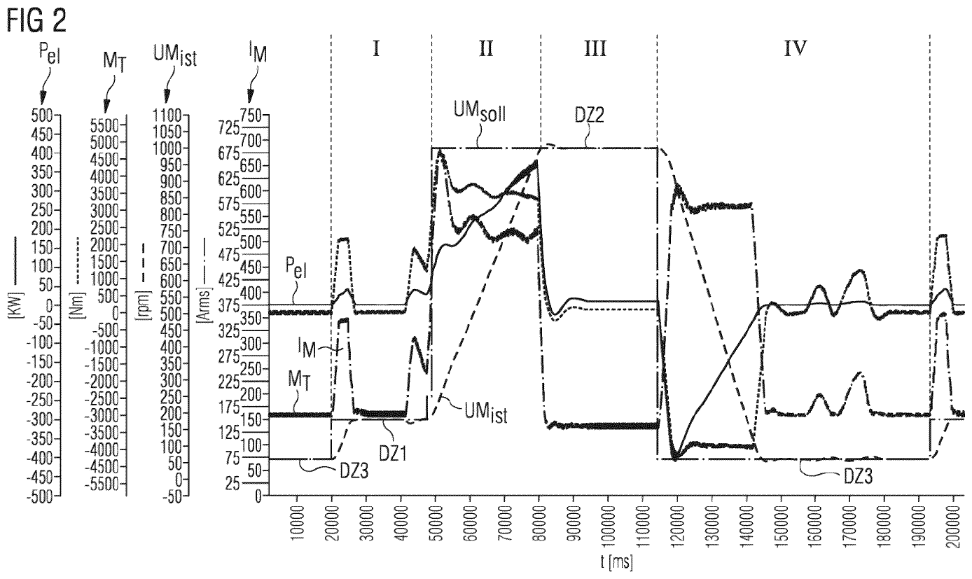

FIG. 2 shows a curve diagram with different time profiles of variables for monitoring a centrifuge over a cycle of centrifuge operation in connection with the different embodiments of the present invention. The time t is plotted on the abscissa in ms. Different variables in connection with an operating cycle of a peeler centrifuge are plotted by way of example on the ordinate; in each case separate axes with the corresponding scales are indicated for these. The bottom curve is the measured speed UM_{actual} of the centrifuge drum. This is given as the number n per minute (rpm=revolutions per minute) and is proportional to the physical value of the angular velocity ω. Superimposed on this is the specified setpoint of the revolutions of the centrifuge drum UMₛₑₜₚₒᵢₙₜ in the same unit. Furthermore, the diagram shows the time profile of the motor current I_{M} in A, which is required to drive the centrifuge drum T and the required electrical power Pₑₗ in kW. Furthermore, for further understanding of the centrifuge operation, the time profile of the torque of the drum M_{T} in Nm is compared with the profiles of the other variables. Accordingly, during operation of the centrifuge, a plurality of variables and/or parameters of the drive can be ascertained and analyzed time-dependently over the course of the separating process.

By comparing the variables relevant for centrifuge operation, the correlations of the variables and/or parameters are disclosed from which the individual operating modes of a cycle of centrifuge operation can be derived. In FIG. 2, these are marked with Roman numerals I to IV. For each of these operating modes, information relating to the separating process and or a centrifuge condition can now be ascertained automatically, for example, by evaluating the corresponding signals of the motor and frequency converter.

In operating mode I, the centrifuge is filled. The empty drum initially rotates at a speed DZ3, which often still corresponds to the peeling speed from the previous operating cycle. In this exemplary embodiment, at the start of the filling mode, the empty drum is accelerated from about 50 to about 175 rpm. The latter is the filling speed DZ1. The measured actual value of the speed of the centrifuge drum UM_{actual} follows the setpoint value UMₛₑₜₚₒᵢₙₜ with a time delay.

In particular, it can be clearly seen that, immediately after the signal ramp of the setpoint value, pronounced maxima of the motor current I_{M}, the required electrical power Pₑₗ and the torque of the drum M_{T} occur; these result from the fact that energy is required to accelerate the empty centrifuge drum from a first speed to a second speed. In accordance with the invention, in the area of the first maximum of operating mode I, the area under the curve of the electrical power can be determined as a function of time via an integrator. From this (from the electrical energy used to increase the rotational energy of the centrifuge drum) rotational moment of inertia of the drum of the centrifuge when empty, the idle moment, can be ascertained. Then, the filling valve V is opened and the suspension enters the drum. When the drum is filled, the incoming mass flow must be accelerated to its angular velocity and so the power consumption of the centrifuge increases significantly during the filling process. Therefore, at the end of area I, a second pronounced maximum of the motor current I_{M} can be seen in FIG. 2, as well as the maximum of the required electrical power Pₑₗ and the torque of the drum M_{T}. The integral of the current consumption above the idle current consumption at this speed is thus a measure of the energy required to accelerate the incoming mass flow to the angular velocity until the centrifuge is finally sufficiently filled. The time integral over the incoming mass flow (=mass) is proportional to the integral of the power consumption of the centrifuge drum (=electrical work). Thus, this energy balance can be used to ascertain the rotational moment of inertia and from this the mass of the filling (rotating mass) of the now filled drum.

At the end of operating mode I, the filling of the centrifuge drum, the filling valve is closed and the speed is “ramped up” to the spin speed DZ2. In this exemplary embodiment, a setpoint value Uₛₑₜₚₒᵢₙₜ is specified for the spin speed of 1000 rpm. The “spinning mode” can be divided into two phases. In operating mode II, the centrifuge needs a lot of energy to reach the setpoint speed Uₛₑₜₚₒᵢₙₜ, as can be seen in FIG. 2 from the increasing profile of the required electrical power. At the same time, the filling material loses mass since the liquid in the suspension is spun. The actual speed UM_{actual} increases linearly until most of the liquid has been separated. As soon as the actual speed UM_{actual} has reached the setpoint speed UMₛₑₜₚₒᵢₙₜ, no additional energy is required to rotate the drum and the motor current I_{M} and the electrical power Pₑₗ and the torque of the drum M_{T} drop abruptly. The operating mode “spinning” is now terminated.

Finally, in operating mode III, the filling material is spun dry at a constant 1000 rpm. This offers the possibility to ascertain the residual moisture by slightly varying the rotational speed. As soon as no more moisture emerges from the filter cake, the rotational moment of inertia of the drum approaches a lower limit value and the end of the “dry spinning” process can thus be recognized. Details of this can be found in the description of FIG. 4.

After operating mode III (dry spinning), a setpoint value UMₛₑₜₚₒᵢₙₜ of 50 ppm is set in this exemplary embodiment. This is the peeling speed DZ3 for peeling the filter cake. In this operating mode IV, the measured actual value of the speed of the centrifuge drum U_{actual} also follows the setpoint value UMₛₑₜₚₒᵢₙₜ with a time delay until it finally remains at the initial level at the peeling speed DZ3. After this operating mode, a new cycle of centrifuge operation begins.

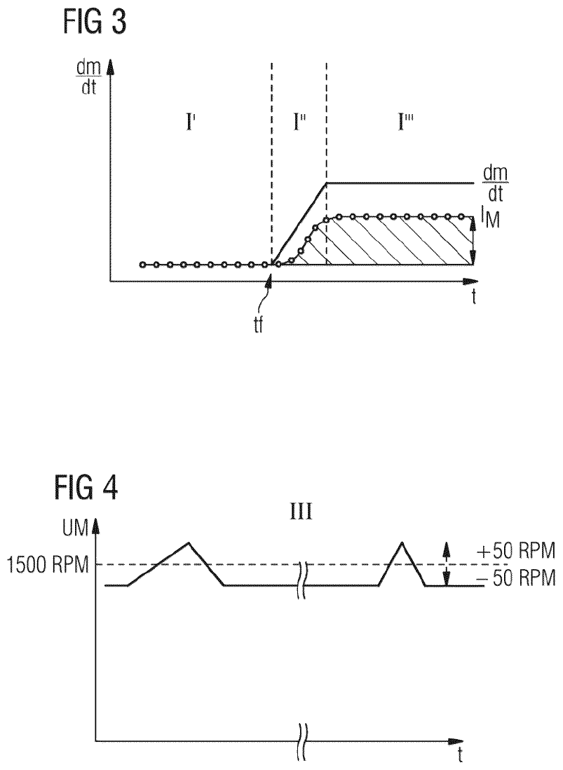

FIG. 3 shows, by way of example, the time profile of the inflow rate dm/dt of a centrifuge and the required motor current I_{M} in the operating mode of filling (see area I in FIG. 2) of a centrifuge drum in accordance with a first embodiment of the invention. In area I′ in FIG. 3, the centrifuge drum is empty (mass inflow rate dm/dt=0). The motor current I_{M} does not change because the drum is driven at a constant speed against a constant frictional resistance. The rotational moment of inertia J_{empty} of the drum of the centrifuge when empty can (as already noted in the description of FIG. 2) be ascertained from a jump in speed by accelerating the drum from the peeling speed to the filling speed (J=2*Erot/ω² where Erot=rotational energy=electrical energy (U*I_{M}*t) and ω=angular velocity). In area I′″ in FIG. 3, the centrifuge drum is filled (dm/dt>0). In order to keep the speed constant, the centrifuge requires additional power to accelerate the incoming mass flow to the respective angular velocity of the drum. In area I′″ in FIG. 3, no further mass is supplied to the drum. The additional energy to be applied is proportional to the area of the integral of power consumption over time. This can, for example, be ascertained via an integrator in the frequency converter of the drive (see FIG. 2). In accordance with the present embodiment, a software application in which the disclosed method is implemented would provide the information about the filling level to a user when a function “ascertaining the filling level” is retrieved without a special sensor having to be installed in the centrifuge drum.

FIG. 4 shows a time profile of a speed UM of a centrifuge in accordance with a further embodiment of the invention. Here, the drum rotation is varied slightly cyclically at a high speed RPM in relation to this speed (here, at DZ2=1500 rpm). Herein, this can, for example, be sinusoidal oscillation or a sawtooth. This occurs in particular in the dry spinning range (see operating mode III in FIG. 2). The change in angular velocity is measured. When the drum is accelerated, the motor energy has to apply energy. This can be derived from the current required by the motor. When the drum brakes, the motor acts like a generator and converts the mechanical energy of the machine back into electrical energy. The converter must then h “get rid of” the energy, which can be measured by the voltage drop across the resistors in the converter. Here, the rotational moment of inertia of the drum can also be determined via the energy balances. If, as in FIG. 4, the centrifuge is run cyclically between two speeds with a defined acceleration or braking energy, then the rotational moment of inertia can be periodically measured therefrom. This requires a cyclic query of the frequency converter power or an electricity meter. To implement this, this query would have to be implemented in the system controller. A small variation of, for example, +/−50 rpm in relation to the speed of 1500 rpm is not important for the separating process. With dozens of kilos of additional weight of the separated solids from a suspension and at several thousand revolutions, the acceleration energy of the rising ramp or the braking of the falling ramp can be used to ascertain the moment of inertia during the drying process. In accordance with the disclosed embodiments of the invention, easily measurable energy for acceleration or controlled braking energy must be used and the time change in angular velocity dω/dt must be recorded. The sawtooth curve shown in FIG. 4 can be used to bring about a change in energy over time by either accelerating or braking the drum with a constant force and using the change in angular velocity to calculate the rotational moment of inertia or by specifying the change in angular velocity as a function of time and determining the power required for this. The exemplary embodiment shown in FIG. 4 shows two cycles or variations of the speed at different times. A comparison of the rotating mass (inertial mass) ascertained during each cycle can be used to determine the residual moisture of the filter cake. If there is still some residual moisture, then the rotating mass decreases over time. Ultimately, the residual moisture will approach a limit value over time, whereupon the spinning process ends (possibly earlier than originally set) and the filter cake can be mechanically removed once the peeling speed (DZ3) has been reached.

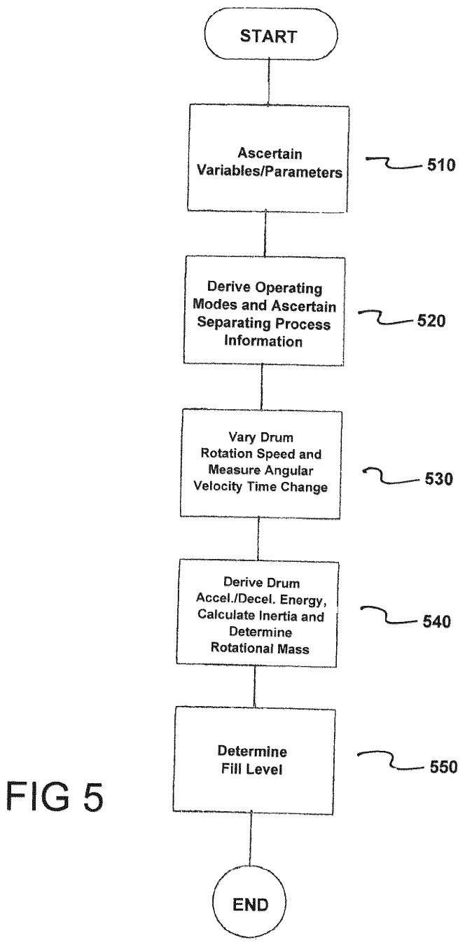

FIG. 5 is a flowchart of the method for monitoring a centrifuge Z for solid-liquid separation of a suspension SUS, comprising a centrifuge drum T, which is connected to at least one frequency-controlled drive for generating a rotation of the centrifuge drum T. The method comprises ascertaining a plurality of variables and parameters of the at least one frequency-controlled drive time-dependently over a course of a separating process during operation of the centrifuge as indicated in step 510.

Next, operating modes I, II, III, IV of a cycle of centrifuge operation are derived from a correlation of the variables and parameters of the drive and information relating to the separating process automatically depending on a derived operating mode is ascertained, as indicated in step 520.

Next, a speed of the drum rotation cyclically over time is varied and a time change in angular velocity is measured at a high speed DZ2, as indicated in step 530.

Next, the energy for acceleration and deceleration of the drum is derived from the measured time change in angular velocity, the rotational moment of inertia of the drum is calculated and a rotating mass is determined from the calculated rotational moment of inertia of the drum, as indicated in step 540.

Next, the fill level of the centrifuge drum is determined based on the calculated rotational moment of inertia of the drum taking into account an idle moment of the drum, as indicated in step 550.

The invention and the described developments are preferably realized in software and in firmware or in a microchip, for example using a special electrical circuit, or implemented in a combination of software and hardware, such as, for example a software module that can be read into the controller of the frequency converter.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-8. (canceled)

9. A method for monitoring a centrifuge for solid-liquid separation of a suspension, comprising a centrifuge drum, which is connected to at least one frequency-controlled drive for generating a rotation of the centrifuge drum, the method comprising:
ascertaining a plurality of variables and parameters of the at least one frequency-controlled drive time-dependently over a course of a separating process during operation of the centrifuge;
deriving operating modes of a cycle of centrifuge operation from a correlation of the variables and parameters of the drive and ascertaining information relating to the separating process automatically depending on a derived operating mode;
varying a speed of the drum rotation cyclically over time at a high speed and measuring a time change in angular velocity;
deriving an energy for acceleration and deceleration of the drum from the measured time change in angular velocity, calculating a rotational moment of inertia of the drum and determining a rotating mass from the calculated rotational moment of inertia of the drum; and
determining a fill level of the centrifuge drum based on the calculated rotational moment of inertia of the drum taking into account an idle moment of the drum.

10. The method as claimed in claim 9, further comprising:
determining a residual moisture of a filter cake at the high speed by comparing the rotating masses of at least two cycles of the speed variants, which becomes constant upon complete dehumidification.

11. A device for monitoring a centrifuge for solid-liquid separation of a suspension, comprising a centrifuge drum, which is connected to at least one frequency-controlled drive for generating a rotation of the centrifuge drum, the device comprising:
at least one interface for receiving signals from the frequency-controlled drive, and
an evaluation unit, which has a data memory embodied to store the signals received from the interfaces, wherein the evaluation unit is configured to:
ascertain a plurality of variables and parameters of the at least one frequency-controlled drive time-dependently over a course of a separating process during operation of the centrifuge;
derive operating modes of a cycle of centrifuge operation from q correlation of the variables and parameters of the drive and ascertain information relating to the separating process automatically depending on a derived operating mode;
vary a speed of the drum rotation cyclically over time at a high speed and measure a time change in angular velocity;
derive an energy for acceleration and deceleration of the drum from the measured time change in angular velocity, calculate a rotational moment of inertia of the drum and determine a rotating mass from the calculated rotational moment of inertia of the drum; and
determine a fill level of the centrifuge drum based on the calculated rotational moment of inertia of the drum taking into account an idle moment of the drum.

12. A non-transitory computer-readable medium encoded with a computer program comprising commands which, when executed by a processor of a computer, cause the processor to computer to monitor a centrifuge for solid-liquid separation of a suspension, comprising a centrifuge drum, which is connected to at least one frequency-controlled drive for generating a rotation of the centrifuge drum, the computer program comprising:
program code for ascertaining a plurality of variables and parameters of the at least one frequency-controlled drive time-dependently over a course of a separating process during operation of the centrifuge;
program code for deriving operating modes of a cycle of centrifuge operation from q correlation of the variables and parameters of the drive and ascertaining information relating to the separating process automatically depending on a derived operating mode;
program code for varying a speed of the drum rotation cyclically over time at a high speed and measuring a time change in angular velocity;
program code for deriving an energy for acceleration and deceleration of the drum from the measured time change in angular velocity, calculating a rotational moment of inertia of the drum and determining a rotating mass from the calculated rotational moment of inertia of the drum; and
program code for determining a fill level of the centrifuge drum based on the calculated rotational moment of inertia of the drum taking into account an idle moment of the drum.
